(19) United States
(12) Patent Application Publication
(10) Pub. No.: US 2009/0277807 A1
(43) Pub. Date: Nov. 12, 2009

(54) Used oil container

(75) Inventors: George McLure Sawyer, Norwich, CT (US); Joseph Weinberger, East Brunswick, NJ (US)

Correspondence Address: HEDMAN & COSTIGAN P.C., 1185 AVENUE OF THE AMERICAS, NEW YORK, NY, 10036, US

(73) Assignee: The Weinberger Group

(21) Appl. No.: 12/151,336

(22) Filed: May 6, 2008

(51) Int. Cl. F16N 31/02; B65D 79/00; B65D 85/00; B65D 69/00; B65D 1/36; F16N 33/00

(52) U.S. Cl. 206/223; 220/573

(57) ABSTRACT

A used oil container comprising a sealable container body having a top, a bottom and sides, the top having a sloping configuration toward one or more openings through which the used oil can enter the container, a threaded shaft adapted to extend from the top of the container body in the area of the one or more openings that conforms to the threaded receiver on a used oil filter, a compartment on one or more of the top, bottom or side of the container body adapted for accepting a new oil filter prior to use, wherein the treaded shaft is adapted to receive a used oil filter to seal the one or more openings of the container.

### FIELD OF THE INVENTION

The present invention relates generally to the field of containers for fluids, and more particularly to containers for holding used motor oil for reclamation.

### BACKGROUND OF THE INVENTION

Engines, as used in automobiles, trucks, boats, planes, power equipment and the like, require oil to lubricate moving parts. The oil is used to prevent excess wear, increase efficiency and increase engine life. However, oil used in engines tends to break down with use over a period of time, such that the lubricity is reduced and the potential for wear increases. Additionally, oil picks up particulate contaminates caused by engine wear that can score engine parts, also reducing engine efficiency and engine life. Therefore, the oil and oil filter must be changed regularly to keep an engine running well.

The used oil removed from the vehicle is a hazardous waste that must be disposed of properly to protect the environment. Due to the severe environmental impact when improperly disposed of, recycling of used motor oil has become required by law throughout the United States and abroad. Generally, the used oil is brought to a reclamation center where it is recycled for reuse and/or proper disposal. This requirement has led to the need for containers to hold the used oil for transport to a recycling or reclamation center.

Because of the high volume of used oil recovered at commercial service facilities, such as service stations, car dealerships, etc., 55 gallon steel drums and the like have been designated for the storage and transport of used oil to the recycle or reclamation center. However, the “weekend mechanic” or car owner that wishes to change the oil on their own car must make other provisions. Often the container used by the car owner changing their own oil is an old milk jug or similar household fluid container. This requires the user to drain the used oil into a collection pan and then transfer the used oil from the collection pan into the fluid container, risking spillage.

In this regard, there is often more than 5 quarts of oil in an automobile or truck, including within the filter, which is drained from the vehicle when the oil and oil filter is changed. Where most household fluid containers hold about a gallon, there is often the need for multiple containers when emptying the collection pan. Not only is this inconvenient for the user, to first collect the oil in a collection pan and then transfer it into a fluid container, but having to stop the transfer when a first fluid container is full and resume the transfer to a second container creates potential problems in knowing when the first container is full and spillage as flow from the pan is stopped when changing fluid containers.

Moreover, since the user needs to transport the used oil from their garage to the recycle or reclamation center, the container must be sealable, so that the used oil does not leak or spill during transportation.

Additionally, the used oil filter, also containing oil trapped in the filter, must be properly disposed of. Often the user will merely turn the filter over above the used oil in the collection pan for several seconds to drain the excess oil, then throw the filter into the garbage, where the oil trapped in the filter elements and elsewhere in the filter, albeit minor compared to the oil recovered, is introduced into the environment.

There is therefore the need for an improved container for used oil, which will hold the amount of used oil generally drained from a vehicle, including the oil filter, for transport to an oil recycling or reclamation center. There is also the need for a used oil container that can hold the oil filter as well, so that it too can be properly drained and disposed of. There is further the need to make the container sealable, to avoid spills during transport to the recycling or reclamation center.

### SUMMARY OF THE INVENTION

This and other objects are achieved by the present invention which is directed to a used oil container comprising a sealable container body having a top, a bottom and sides, the top having a sloping configuration toward one or more openings through which the used oil can enter the container, a threaded shaft adapted to extend from the top of the container body in the area of the one or more openings that conforms to the threaded receiver on a used oil filter, a compartment on one or more of the top, bottom or side of the container body adapted for accepting a new oil filter prior to use, wherein the treaded shaft is adapted to receive a used oil filter to seal the one or more openings of the container.

In a preferred embodiment, the container is made of an oil resistant recyclable plastic, which can either be disposed of with the used oil or reused after the used oil and used oil filter are removed and disposed of at an oil reclamation center. For such an application, the use of polyethylene is considered to be suitable, with the thickness depending on whether the container is designed to be disposable or reusable. Of course, the disposable container would be formed of a thinner material, closer to the thickness of a plastic milk container, to reduce the recycled material, while the reusable container would be formed of a thicker material, closer to the thickness of a plastic gas can, for durability. Thus, the thickness would be a matter of design choice.

Similarly, the dimensions of the container are a matter of design choice. However, it is preferred that the container have a larger base, i.e., greater length and width than height, so as to be more stable when the container filled with used oil is placed in the trunk of a car, etc., for transport to the reclamation facility. Additionally, it is intended that the unused container be stackable, to aid in the shipment, storage and display of the item prior to sale.

The container could be first sold with the proper sized new oil filter for a particular make and model of vehicle, having the proper threaded shaft for receiving the oil filter. Thus, the user can either purchase a new container with the new filter when changing the oil and filter for the same vehicle or can purchase only the new oil filter and reuse the container by emptying it at the reclamation center.

In this regard, the container preferably includes a second opening for draining the used oil from the container. The drainage opening is preferably a second opening so that removal of the used oil filter sealing the one or more openings before drainage permits easy drainage of the used oil from the container. It is also preferred that the container have a flat area outside the one or more openings for receiving the used oil, spaced from the threaded shaft, for the gasket of the used oil filter to seat and seal the one or more openings.

Although the threaded shaft can be formed integrally with the container itself, it is also contemplated that the threaded shaft can be formed as a separate element to be attached to the container. In such an embodiment, the container can have a common receptacle, such as a threaded opening or snap fit opening that receives one end of the threaded shaft. The other end of the threaded shaft can be sized particularly to the threaded opening in the oil filter.

The preferred compartment for holding a new oil filter is preferably formed in the top, bottom or one of the side walls of the container, so that the new oil filter fits within the compartment. When the treaded shaft is a separate element, it may also be contained within the compartment with the new oil filter. The compartment is preferably open along one side for removal of the new oil filter and can be closed with a removable cover. In its preferred embodiment, the cover is formed of plastic sheet material that has adhesive on its edges for attachment to the top, bottom or side walls adjacent the compartment. Of course, other covers may be used, including snap on covers with or without hinges, etc.

In a preferred embodiment, the top of the container further has retaining walls extending upwardly therefrom, to form a drain pan and contain the used oil being drained from the vehicle. The retaining walls can be formed about the perimeter as an extension of the side walls or may extend from an interior portion of the top. Alternatively or in addition to the retaining walls, the container may have a fitting for receiving a drain hose from the vehicle drain plug, as described in U.S. patent application Ser. No. 11/899,087 filed on Sep. 4, 2007, currently pending, or the like. In an embodiment with such a fitting, the used oil can be transferred directly from the drain plug on the vehicle oil pan into the container without the need to use the sloped top as a drain pan.

### BRIEF DESCRIPTION OF THE DRAWINGS

The present invention will be better understood when considered in view of the attached drawings, in which like reference characters indicate like parts. The drawings, however, are presented merely to illustrate the preferred embodiment of the invention without limiting the invention in any manner whatsoever.

FIG. 1 is an exploded top perspective view of a preferred used oil container according to the present invention.

FIG. 2 is an exploded bottom perspective view of the preferred used oil container according to the present invention, with a new oil filter as intended to be offered to consumers.

FIG. 3 is a perspective view of the preferred used oil container of FIG. 1 with the used oil filter sealing the opening for receiving the used oil.

FIG. 4 is a plan view of the preferred used oil container of FIG. 1 with the used oil filter sealing the opening for receiving the used oil.

FIG. 5 is a cross section view of the preferred used oil container through Section A-A of FIG. 4 with the used oil filter sealing the opening for receiving the used oil.

FIG. 6 is a cross section view of a preferred used oil container through Section A-A of FIG. 4 with a new oil filter stored in the compartment.

FIG. 7A is a perspective view of a threaded shaft for use with the present invention which connects to the container using a snap in fitting.

FIG. 7B is a perspective view of a threaded shaft for use with the present invention which connects to the container using a threaded fitting.

### DETAILED DESCRIPTION OF THE PREFERRED EMBODIMENT

The following description is directed to a preferred embodiment of the present invention and is provided to better understand the invention without limiting the scope of the invention in any manner whatsoever.

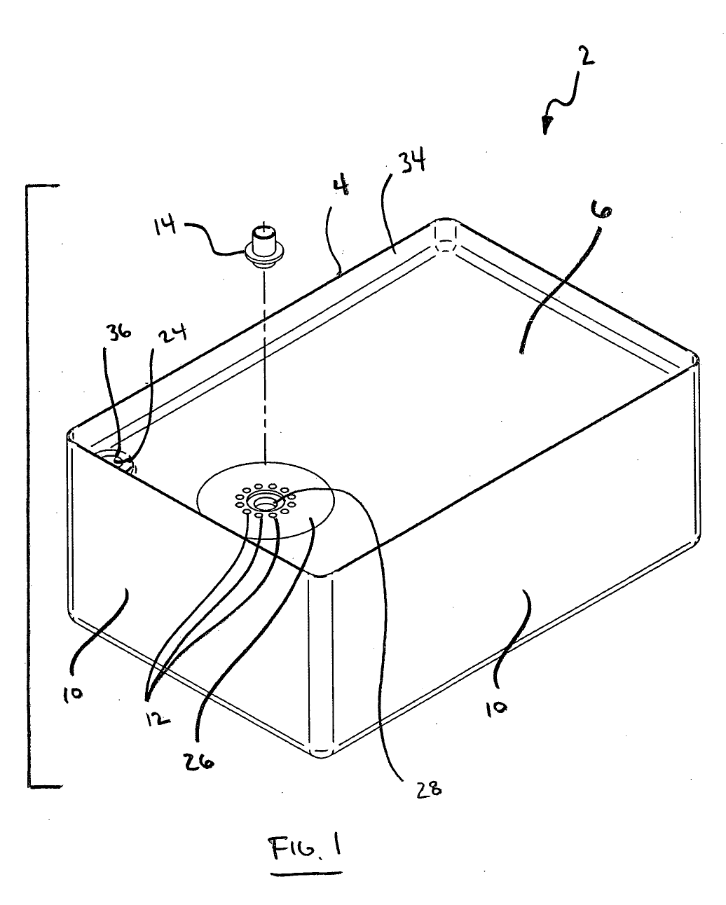

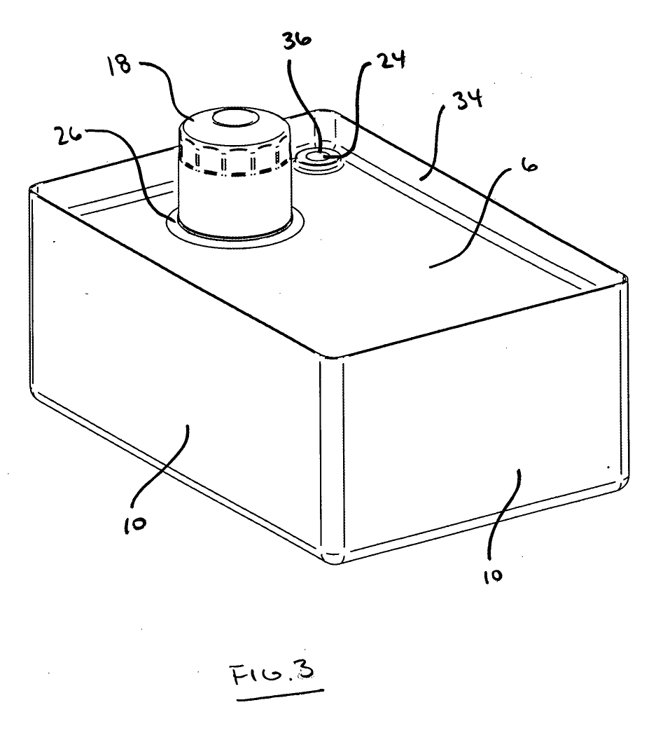

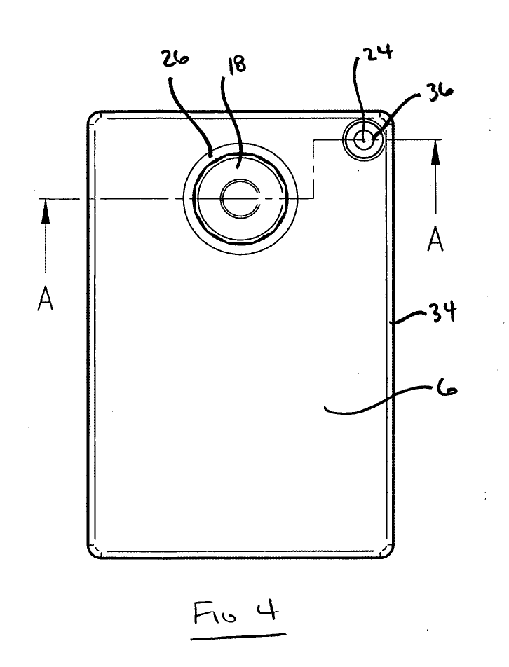

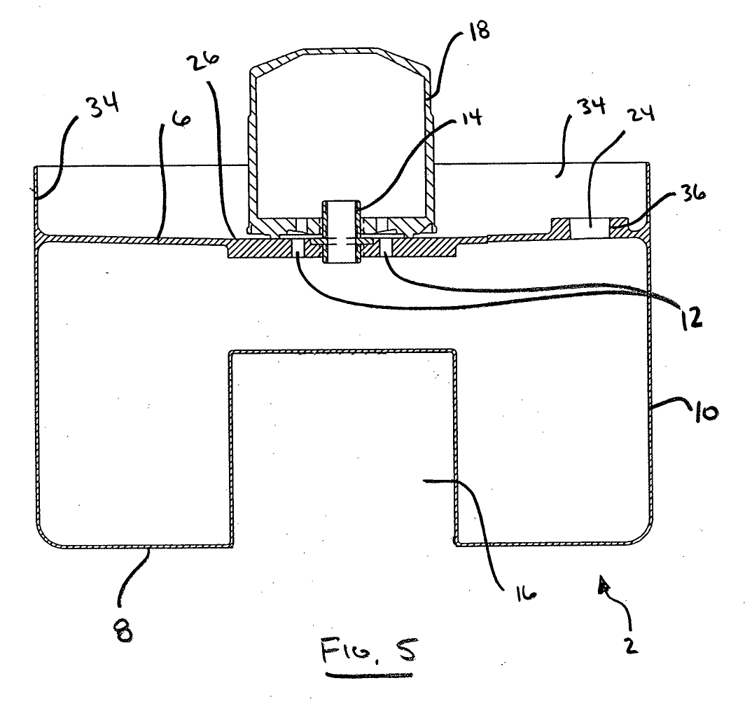

As shown in the drawings, and each of FIGS. 1-4, the present invention is directed to a used oil container 2 comprising a sealable container body 4 having a top 6, a bottom 8 and sides 10. The top 6 has a sloping configuration toward one or more openings 12 through which the used oil can enter the container 2. A threaded shaft 14 is adapted to extend from the top 6 of the container body 4 in the area of the one or more openings 12, and conforms to the threaded receiver on a used oil filter 18. Thus, once the used oil has been received into the container 2, the used oil filter can be screwed onto the threaded shaft 14 to seal the one or more openings 12 and allow the used oil from the used oil filter to also drain into the container 2 through the one or more openings 12, as shown in FIGS. 3 and 5.

A compartment 16 shown located on the bottom 8 of the container body 4 is adapted for accepting a new oil filter 20 prior to use. As such, the used oil container 2 can be sold with a new oil filter contained in the compartment 16, where the treaded shaft 14 is adapted to receive a used oil filter that matches the treads of the new oil filter sold with the container 2.

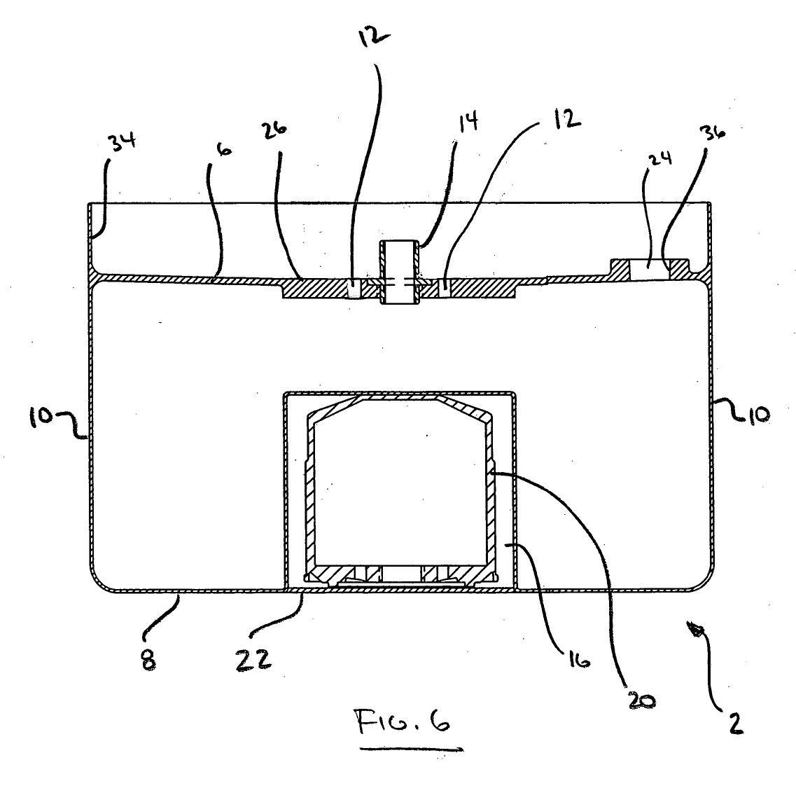

In its preferred embodiment, shown in FIG. 6, the compartment 16 containing the new oil filter 20 is closed with a removable cover 22. Thus, the consumer purchases the container 2 with the new filter 20 that fits the make and model of the vehicle on which the oil is to be changed.

Since the dimensions of the threaded receptacle of the new oil filter 20 are presumably the same as the used oil filter 18 being replaced, the threaded shaft 14 is properly sized for the used oil filter 18 once removed from the vehicle. The user can either purchase a new container 2 with the new oil filter 20 when changing the oil and used oil filter 18 for the same vehicle or can purchase a new oil filter alone and reuse the container 2 by emptying it at a reclamation center.

In this regard, the container 2 preferably includes a second opening 24 for draining the used oil from the container 2. The drainage opening 24 is preferably a second opening so that removal of the used oil filter 18 sealing the one or more openings 12 before drainage creates an air vent for easy drainage of the used oil from the container 2. Although not shown, it is understood that any closure member, such as a threaded cap or plug, can be used to seal off the drainage opening 24.

It is also preferred that the container 2 have a flat area 26 outside the one or more openings 12 for receiving the used oil, appropriately spaced from the threaded shaft 14 for the gasket of the used oil filter 18 to seat and seal the used oil filter 18 over the one or more openings 12.

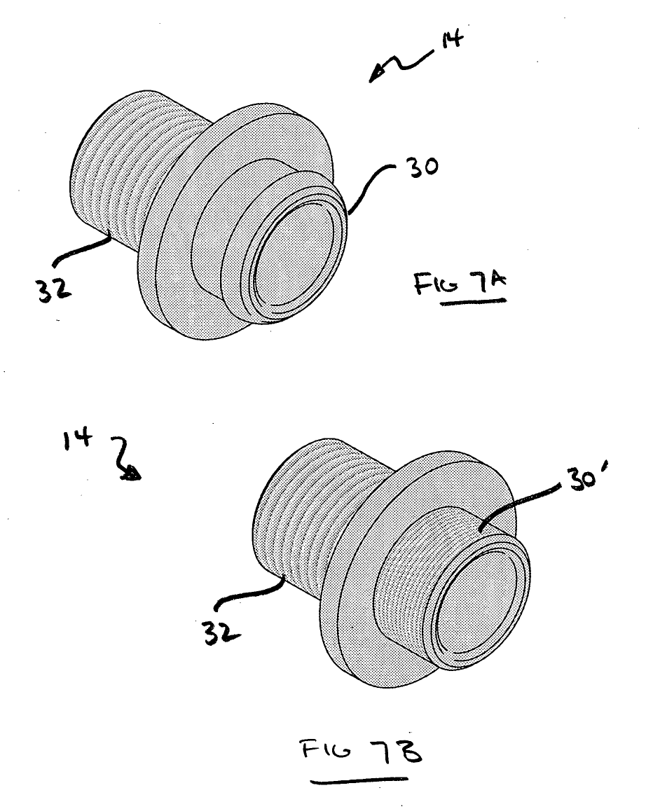

Although the threaded shaft 14 can be formed integrally with the container 2 on the top 6 of the container 2, it is also contemplated that the threaded shaft 14 can be a separate element. In such an embodiment, examples of which are shown in FIGS. 7A and 7B, the container 2 has a common receptacle 28, such as either a threaded opening or snap fit opening, which receives a first part 30 of the threaded shaft 14. The first part 30 of the threaded shaft 14 mates with and engages the common receptacle 28 to maintain the second part 32 of the threaded shaft 14 in fixed relation to the top 6 to retain the used oil filter 18. This configuration permits the use of a universal first part 30 with a variety of specifically sized second parts 32 to retain the oil filters 18 of a variety of specific makes and models of vehicles.

In this regard, FIG. 7A shows a threaded shaft 14 with a snap-fit end 30 that is adapted to fit into a snap-fit receptacle 28 in the container top 6. As an alternative, FIG. 7 B shows a threaded shaft 14 with a threaded end 30′ that is adapted to fit into a snap-fit receptacle 28 in the container top 6. In these embodiments, it is envisioned that the preferred threaded shaft 14 has a universal attachment to the container 2 at one end and a threaded second part 32 that retains the user specific oil filter 18.

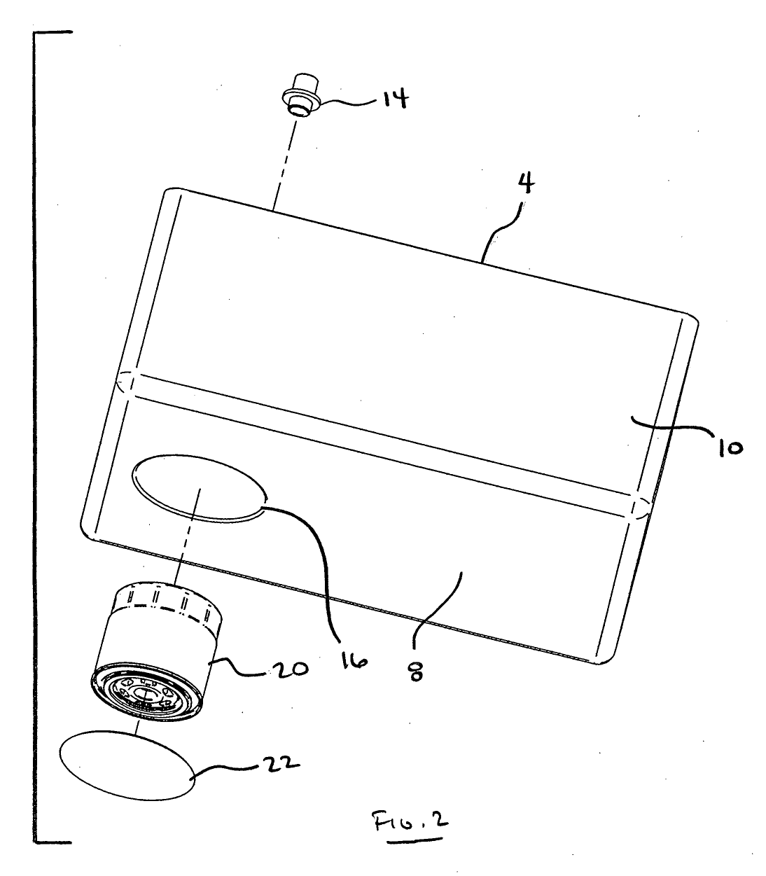

The removable cover 22 that retains the new oil filter 20 in the compartment 16 can be any suitable type that retains the new oil filter 20. In its preferred embodiment shown in FIGS. 2 and 6, the cover 22 is formed of plastic sheet material that has adhesive on its edges for attachment to container bottom 8 adjacent the compartment 16. Of course, other covers may be used, including snap on covers, hinged covers and the like, the particular cover 22 being a matter of design choice.

In the preferred embodiment shown, the top 6 of the container 2 further has retaining walls 34 extending upwardly therefrom, to form a drain pan and contain the used oil being drained from the vehicle. The retaining walls 34 can be formed about the perimeter of the top 6 as an extension of the side walls 10 or may extend from an interior portion of the top 6 (not shown).

Alternatively or in addition to the retaining walls 34, the container 2 may have a fitting 36 for receiving a drain hose from the vehicle drain plug. The fitting 36 for receiving a drain hose may be any suitable type adapted to securely engage the drain hose, including but not limited to such items as a threaded fitting, a snap fitting, a friction fitting, a clip, a compression fitting and a twist-on fitting. In an embodiment with such a fitting 36, the used oil can be transferred directly from the drain plug on the vehicle oil pan into the container 2, without the need to use the sloped top 6 as a drain pan.

Although the fitting 36 is shown in the present embodiment as incorporated into the drainage opening 24, to minimize the number of openings in the container that ultimately must be sealed when used oil fills the container 2, it could be formed individually if desired. Additionally, although the fitting 36 is described as suitable for receiving a drain hose, it is contemplated that such a drain hose may be included with the container 2 of the present invention, so as to complete a package for the user.

The material of the container body 4 should be an oil resistant material, so that it is not degraded by exposure to oil, and is preferably a recyclable material so that, whether or not disposable, the material can be recycled when the service life of the container 2 is over. Keeping this in mind, polyethylene has been found to be a suitable material for forming the container 2.

The container 2 can be made to be disposable or reusable, and it is contemplated that the disposable container uses as little recyclable material as possible while retaining the integrity to ensure that it does not fail and spill the used oil. Conversely, the reusable container should be strong enough to stand up to repeated uses, storage and transportation. Depending on the intention of the manufacturer, it is contemplated that the thickness of the material used to form the container body 4 can be from about 0.015 mil to about 100 mil.

In its preferred embodiment the container 2 has a larger base, i.e., greater length and width than height, so as to be more stable when the container 2 filled with used oil is placed in the trunk of a car, etc., for transport to the reclamation facility. It has been found that a container having a bottom with length and width dimensions of about 16 inches by about 8 inches, and about 8 inches high is sufficient to hold up to about 7 quarts of used oil and resist toppling during normal driving conditions.

Additionally, it is intended that the unused container be stackable, to aid in the shipment, storage and display of the item prior to sale.

Variations, modifications and alterations to the preferred embodiment of the present invention described above will make themselves apparent to those skilled in the art. All such changes are intended to fall within the spirit and scope of the present invention, limited solely by the appended claims.

All patents referred to herein are hereby incorporated by reference.

I claim:

1. A used oil container comprising a sealable container body having a top, a bottom and sides, the top having a sloping configuration toward one or more openings through which the used oil can enter the container, a threaded shaft adapted to extend from the top of the container body in the area of the one or more openings that conforms to the threaded receiver on a used oil filter, a compartment on one or more of the top, bottom or side of the container body adapted for accepting a new oil filter prior to use, wherein the treaded shaft is adapted to receive a used oil filter to seal the one or more openings of the container.

2. The used oil container of claim 1 wherein the container is formed of an oil resistant plastic material.

3. The used oil container of claim 2 wherein the container is formed of polyethylene.

4. The used oil container of claim 2 wherein thickness of at least a portion of the oil resistant plastic material comprising at least one of the top, bottom and sides has a thickness of from about 0.015 to about 100 mil.

5. The used oil container of claim 1 further comprising a drain opening for emptying the used oil from the container.

6. The used oil container of claim 1 further comprising an opening adapted to accept a drain hose from a drain plug on a vehicle oil pan for receiving the used motor oil into the container.

7. The used oil container of claim 1 further comprising a flat area outside the one or more openings for receiving the used oil, spaced from the threaded shaft, for the gasket of the used oil filter to seat and seal the one or more openings.

8. The used oil container of claim 1 wherein the threaded shaft is formed integrally with the top of the used oil container.

9. The used oil container of claim 1 wherein the threaded shaft is attached to the top of the container by threading the threaded shaft into a threaded opening on the container top.

10. The used oil container of claim 1 wherein the threaded shaft is attached to the top of the container by snap fitting the threaded shaft into a snap fit opening on the container top.

11. The used oil container of claim 1 wherein the compartment for holding a new oil filter is formed in one of the top, the bottom or one of the sides of the container.

12. The used oil container of claim 1 further comprising a removable cover for maintaining the compartment in a closed configuration with a new oil filter contained therein.

13. The used oil container of claim 1 further comprising retaining walls extending upwardly from the top of the container to retain used oil being drained into the one or more openings.

14. The used oil container of claim 13 wherein the retaining walls are formed as an extension of the side walls or may extend from an interior portion of the top

15. The used oil container of claim 13 wherein the retaining walls extend from an interior portion of the top.

16. The used oil container of claim 1 further comprising a fitting for receiving a drain hose from the vehicle drain plug.

17. The used oil container of claim 16 wherein the fitting for receiving a drain hose is taken from a threaded fitting, a snap in fitting, a friction fitting, a clip, a compression fitting and a twist on fitting.
